(19) United States
(12) Patent Application Publication
(10) Pub. No.: US 2005/0029398 A1
(43) Pub. Date: Feb. 10, 2005

(54) Flying craft camera and sensor mechanized lift platform

(76) Inventors: Jerry D. Lowe, Woodland Park, CO (US); Brent K. De Ruyter, Simi Valley, CA (US)

Correspondence Address: BRENT DE RUYTER, 790 COPPERTREE COURT, SIMI VALLEY, CA, 93065, US

(21) Appl. No.: 10/633,347

(22) Filed: Aug. 4, 2003

(51) Int. Cl. B64C 1/20

(52) U.S. Cl. 244/118.1

(57) ABSTRACT

Disclosed herein is a mechanized lift platform for extending a camera and sensor, individually or collectively, out of a flying craft and retracting the camera and sensor back into the flying craft upon completion of use. The camera and sensor in the fully extended position provides a full field of view. The camera and sensor is extended and retracted through concealment doors. The concealment doors are closed when the camera and sensor are in the fully retracted position such that the lift platform and camera and sensor are not subject to any outside environment and the flying craft is able to retain its original flying characteristics. The camera and sensor mechanized lift platform has particular application for aerial photography, video, sound collection and multimedia. A method of capturing images, sounds and data comprising the steps of: Providing a device for extending a camera and sensor outside a flying craft whereby the camera and sensor can be completely retracted into the aircraft, having a platform structure to mount a camera and sensor, a power source, mechanized liner motion structure installed in flying craft to stabilize and guide the camera and sensor mounting platform during extension and retraction, concealment doors to open and close, relay switches to the flying craft cockpit and/or cabin to operate the lift platform and concealment doors, viewing and recording equipment connected to camera and sensor; and opening the concealment doors and extending the camera and sensor during flight to collect images, sounds and data or any combination thereof and display said collected images in a live graphical display in aircraft or to a remote site and upon completion of camera and sensor activities, retracting the lift platform inside the aircraft and closing the concealment doors. In a preferred embodiment of the invention the camera and sensor mechanized lift platform is extended through opened concealment doors during flight to collect images, sounds and data or any combination thereof and upon completion of camera and sensor activities, the lift platform is retracted inside the aircraft and the concealment doors are closed such that the original flying craft speed, maneuverability and aerodynamic characteristics are not altered.

### FIELD OF THE INVENTION

This invention relates to flying craft. More particularly this invention relates to a mechanized lift platform that extends and retracts a device for capturing images, sounds and data, individually and collectively, from a flying craft to include but not limited to airplanes, helicopters, blimps, hot air balloons and space crafts. This invention has particular applicability to cameras and sensors installed in flying craft.

### BACKGROUND OF THE INVENTION

Flying craft are utilized to capture images, sounds and data, individually and collectively. Aerial image, sound and datum capturing devices include cameras and sensors. Aerial cameras and sensors are affixed to the flying craft either internally or externally. Internal cameras and sensors are mounted to the structure inside the body of the flying craft. Internally mounted cameras and sensors are able to capture images, sounds and data using a window, retractable door or permanent opening in the flying craft. Internally mounted cameras and sensors have minimal if any exposure to the environment outside the flying craft. In contrast, external cameras and sensors are mounted to the exterior structure of a flying craft. An externally mounted camera is subject to the environment outside the flying craft at all times. Both internally and externally mounted cameras and sensors uses include but are not limited to surveillance, reconnaissance, monitoring, surveying, broadcasting and motion pictures.

Both internally mounted and externally mounted cameras and sensors are limited by their respective installations. The internally mounted camera has a limited field of view. The flying craft interior structure will obstruct image capturing during lateral rotation of the camera. Furthermore, interior arrangement modifications to accommodate a camera or sensor inside the body of a flying craft create a single function aircraft.

Externally installed cameras and sensors have a specific set of limitations. Externally mounted cameras and sensors affect aerodynamic properties of the flying craft at all limes. The change in aerodynamic properties resulting from an externally mounted device reduces flying craft performance and increases structural stress and fatigue. Furthermore, aerial cameras and sensors are expensive. Flying craft with externally mounted cameras and sensors must be parked in a secured area to prevent damage and deter theft. Under the current political environment there is a requirement to conceal cameras and sensors from the public and/or foreign governments. The mechanized lift platform proposed in this document satisfies this requirement.

What is needed is a method of aerially capturing images, sounds and data collectively or individually, by combining the functionality of the internally and externally mounted cameras. What is needed is a mechanism that can extend a camera and sensor outside the flying craft for full field of view and retract the camera and sensor inside the body of the aircraft upon completion of image, sound and/or datum collection to maximize the flying craft performance. What is needed is a flying craft that can be used to capture images, sounds and data and transport passengers and freight.

### OBJECTS OF THE INVENTION

It is an object of this invention to disclose an improved method of aerially capturing images, sounds and data. It is an object of this invention to disclose a mechanized lift platform that extends and retracts a camera and sensor, individually or collectively, from a flying craft. It is an object of this invention to disclose a method to create a multi-role flying craft that is able to aerially capture images, sounds and data and efficiently transport cargo and passengers. It is yet a further objective of this invention to disclose an improved method of aerial photography, video, sound collection and multimedia that is concealed from the public's view.

One aspect of this invention provides for a method of aerially capturing images, sounds and data comprising the steps of: Providing a device for extending a camera and sensor outside a flying craft whereby the camera and sensor can be completely retracted into the aircraft, having a platform structure to mount a camera and sensor, an electric motor to provide power, mechanized liner motion structure installed in flying craft to stabilize and guide the camera and sensor mounting platform during extension and retraction, concealment doors to open and close, relay switches to the flying craft cockpit and/or cabin to operate the lift platform and concealment doors; and opening the concealment doors and extending the camera and sensor during flight to collect images, sounds and data or any combination thereof and upon completion of camera and sensor activities, retracting the lift platform inside the aircraft and closing the concealment doors.

Another aspect of this invention provides for a method of aerial photography, video, sound collection and multimedia and transmitting said captured images, sounds and data to a graphical display comprising the steps of: Providing a device for extending a camera and sensor outside a flying craft whereby the camera and sensor can be completely retracted into the aircraft, having a platform structure to mount a camera and sensor, an electric motor to provide power, mechanized liner motion structure installed in flying craft to stabilize and guide the camera and sensor mounting platform during extension and retraction, concealment doors to open and close, relay switches to the flying craft cockpit and/or cabin to operate the lift platform and concealment doors, multimedia viewing and recording equipment connected to camera and sensor; and opening the concealment doors and extending the camera and sensor during flight to collect images, sounds and data or any combination thereof and display said collected images in a live graphical display in aircraft or to a remote site and upon completion of camera and sensor activities, retracting the lift platform inside the aircraft and closing the concealment doors.

A preferred aspect of this invention provides for a method of creating a multi-role aircraft comprising the steps of: Providing a device for extending a camera and sensor outside a flying craft whereby the camera and sensor can be completely retracted into the aircraft, having a platform structure to mount a camera and sensor, a motor to provide power, mechanized liner motion structure installed in flying craft to stabilize and guide the camera and sensor mounting platform during extension and retraction, concealment doors to open and close, relay switches to the flying craft cockpit and/or cabin to operate the lift platform and concealment doors; and opening the concealment doors and extending the camera and sensor during flight to collect images, sounds and date or any combination thereof and upon completion of camera and sensor activities, retracting the lift platform inside the aircraft and closing the concealment doors such that the camera will be hidden from public view and the original flying craft speed, maneuverability, aerodynamic characteristics and cabin configuration are not altered.

Various other objects, advantages and features of this invention will become apparent to those skilled in the an from the following description in conjunction with the accompanying drawings.

### FIGURES OF THE INVENTION

FIG. 1 is a perspective view of a flying craft with the camera/sensor mechanized lift platform in the fully extended position. FIG. 2 is a perspective view of the camera/sensor mechanized lift platform. FIG. 3 is a model of the lift platform giving reference to individual components that comprise the whole unit.

The following is a discussion and description of the preferred specific embodiments of this invention, such being made with reference to the drawings, wherein the same reference numerals are used to indicate the same or similar parts and/or structure. It should be noted that such discussion and description is not meant to unduly limit the scope of the invention.

### DESCRIPTION OF THE INVENTION

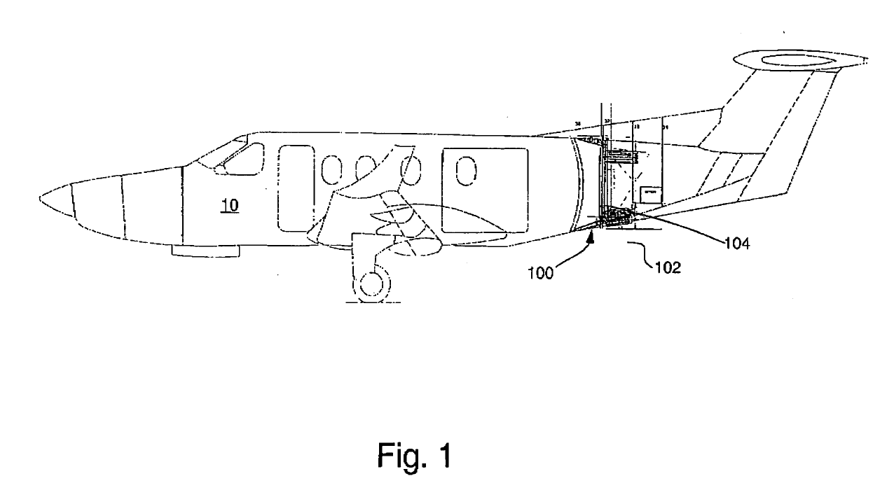

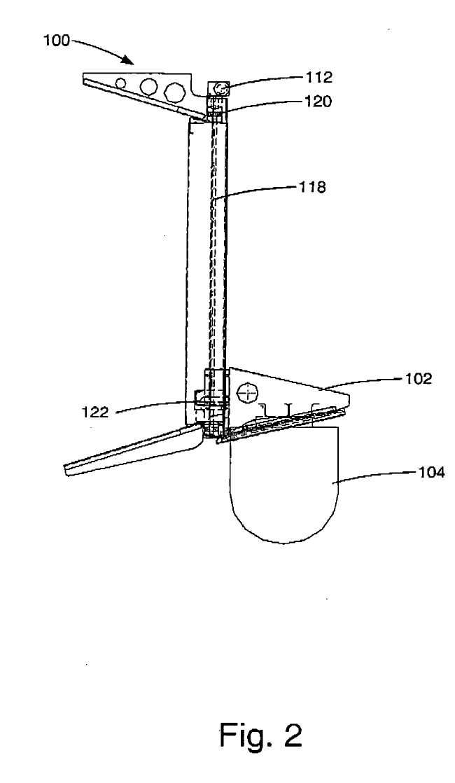

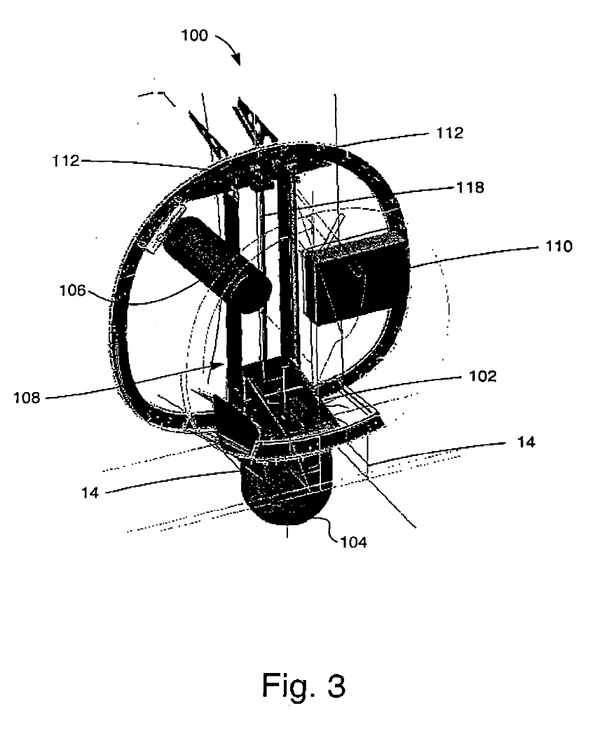

Now turning to the drawings and more particular to FIG. 1 we have a side view of the lift mechanism installed into an aircraft. This installation is in the tail section, however the mechanism can be installed at any location on the craft. A method of installation comprises the steps of: (1) the lift mechanism (2) a concealment door (3) motor drive (4) mounting surface for the equipment or camera. FIG. 2 shows the lift mechanism using a motor drive system that can be powered by an electric motor, hydraulics, pre-stressed springs, air drive or magnetic drive. FIG. 3 shows that the lift mechanism is mounted to existing structure in the flying craft. The mechanism uses parallel sliding rails to control the platform that the camera is mounted to during the movement of the camera from the stowed position 10 the operating position. The mechanism uses at drive system that is attached to the platform to power the camera into position.

1-14. (cancelled)

15. A system for extending and retracting an object outside and inside an outside surface of a body, comprising:
a mounting structure attached within the body;
a platform to which the object is attached;
a linear guide that is connected to the mounting structure, wherein the linear guide is engaged by the platform and comprises a linear structure disposed in parallel to a lineal movement path of the platform to stabilize and direct linear movement of the platform; and
a mechanism for extending and retracting the platform, outside and inside the body, along the linear guide.

16. The system of claim 15, wherein the body is an aircraft.

17. The system of claim 15, wherein the object is a sensor.

18. The system of claim 15, wherein the object is a camera.

19. The system of claim 15, wherein the mechanism is electrically driven.

20. The system of claim 15, wherein the mechanism is hydraulically driven.

21. The system of claim 15, wherein the mechanism is magnetically driven.

22. The system of claim 15, wherein the mechanism is pneumatically driven.

23. The system of claim 15, wherein the mechanism comprises a linear motion screw.

24. The system of claim 15, wherein the mechanism comprises a clutch and brake apparatus.

25. The system of claim 15, wherein the body comprises concealment doors that are opened upon extending the object, and closed upon retracting the object.

26. The system of claim 15, wherein the mounting structure is fitted into the shape of the body so as limit intrusion into the body.

27. A method for extending and retracting an object outside and inside an outer surface of a body, comprising:
attaching the object to a platform; and
extending and retracting a platform outside and inside the body along a linear guide that is engaged by the platform and that comprises a linear structure disposed in parallel to a linear movement path of the platform to stabilize and direct linear movement of the platform, the linear guide being connected to a mounting structure attached within the body.

28. The method of claim 27, wherein the body is an aircraft.

29. The method of claim 27, wherein the object is a sensor.

30. The method of claim 27, wherein the object is a camera.

31. The method of claim 27, wherein the step of extending is performed by an electrically driven mechanism.

32. The method of claim 27, wherein the step of extending is performed by a hydraulically driven mechanism.

33. The method of claim 27, wherein the step of extending is performed by a magnetically driven system.

34. The method of claim 27, wherein the step of extending is performed by a pneumatically driven system.

35. The system of claim 27, wherein the step of extending is performed using a linear motion screw.

36. The system of claim 27, wherein the step of extending is performed using a clutch and brake apparatus.
